(19) United States
(12) Patent Application Publication
(10) Pub. No.: US 2007/0287795 A1
(43) Pub. Date: Dec. 13, 2007

(54) Composite materials from corncob granules and process for preparation

(75) Inventors: Masud Huda, Okemos, MI (US); Venkatesh Balan, East Lansing, MI (US); Lawrence Drzal, Okemos, MI (US); Bruce Dale, Mason, MI (US); Shishir Chundawat, East Lansing, MI (US); Manjusri Misra, Lansing, MI (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 11/811,063

(22) Filed: Jun. 8, 2007

Related U.S. Application Data
(60) Provisional application No. 60/811,865, filed on Jun. 8, 2006.

(51) Int. Cl. C08L 97/00; C08K 11/00; C08K 9/00; C08K 5/00

(52) U.S. Cl. 524/703

(57) ABSTRACT

A composite composition which comprises a synthetic polymer, and corncob granules which have been modified, such as with a chemical reacted with the hydroxyl groups on the granules is described. The corncob granules are modified so as to be compatible with the polymer.

### CROSS-REFERENCE TO RELATED APPLICATIONS

This application claims benefit to U.S. Provisional Application Ser. No. 60/811,865, filed Jun. 8, 2006, which is incorporated herein by reference in its entirety.

### STATEMENT REGARDING FEDERALLY SPONSORED RESEARCH OR DEVELOPMENT

This work was supported by a grant from the National Science Foundation (61-2334, NSF-PREMISE-II). The U.S. government has certain rights to this invention.

### BACKGROUND OF THE INVENTION

(1) Field of the Invention

The present invention relates to biocomposites. Specifically, the present invention relates to composites of a synthetic polymer and corncob granules modified to be compatible with the polymer.

(2) Description of the Related Art

There is a growing interest in the use of natural/bio-fibers/fillers as reinforcements for biodegradable polymers because natural/bio-fibers/fillers have the functional capability to substitute for glass fibers. Furthermore, rising oil prices and increased activity in regards to environmental pollution prevention have also pushed recent research and development of biodegradable polymers. In light of petroleum shortages and pressures for decreasing the dependence on petroleum products, there is an increasing interest in maximizing the use of renewable materials. The use of agricultural resources as source of raw materials to the industry not only provides a renewable source, but could also generate a non-food source of economic development for farming and rural areas. Appropriate research and development in the area of agricultural based fillers/fibers filled plastics could lead to new value-added, non-food uses of agricultural materials. The cost of natural fibers are in general less than the plastic, and thus high fiber loading can result in significant material cost savings. The cost of compounding is unlikely to be much more than for conventional mineral/inorganic based presently used by plastics industry. Due to a virtually inexhaustible supply of agricultural by-product biomaterials, the exploration to effectively utilize this sort of resource is very attractive.

Old technology (Materials and Processing): The use of renewable sources for both polymer matrices and reinforcement material offer an answer to maintaining sustainable development of economically and ecologically attractive structural composite technology. Significant environmental advantages include: preservation of fossil-based raw materials; complete biological degradability; reduction in the volume of refuse; reduction of carbon dioxide released to the atmosphere; as well as increased utilization of agricultural resources. The most important advantages of using polymers are, ease of processing, high productivity and low cost, in combination with their versatility. In fact, polymers can be modified by the use of fillers and reinforcing fibers to suit the high strength/high modulus requirements. Fiber-reinforced polymers offer additional options over other conventional materials when specific properties are required and find applications in diverse fields, ranging from appliances to spacecraft [3-5]. For manufacturing structural as well as semi-structural fiber reinforced thermoplastics, use of natural fibers (such as jute, flax, hemp, sisal, etc.) have been the subject of extensive research in the last few years [6-9]. Agro and forest resources have always played an important role in the plastics industry. Recently, lignocellulosic materials, such as wood, plant fibers, and other natural substances are currently considered potential candidates as cheap biodegradable fibers/fillers for thermoplastics. The research interests in these lignocellulosic materials are attributed to the advantages offered by these fibers over traditional reinforcing materials such as low density, high specific properties, non-abrasive nature, high level of filler loadings, availability, renewability, safe working environment, and the like. [10-12). However, these improvements are usually accompanied by losses in the ductility and impact resistance of the composites [13,14].

In recent years, the use of lignocellulosics as fillers and reinforcements in thermoplastics has been gaining acceptance in commodity plastics applications. Natural fibers are composed of various organic materials (primarily cellulose, as well as hemicellulose and lignin) (as seen in FIG. 3) and therefore their thermal treatment leads to a variety of physical and chemical changes. Thermal degradation of those fibers leads to poor organoleptic properties, such as odor and colors, and moreover to deterioration of their mechanical properties. It also results in the generation of gaseous products, when processing takes place at temperatures above 200° C., which can create high porosity, low density and reduced mechanical properties. The properties of the interface between the fiber and matrix are critical to many properties of a composite material, which are the result of many influences, such as fiber roughness, chemistry of the fiber surface and/or coating and properties of the matrix [5,15,16]. Much attention has been given to the modification of the fibers and/or polymer by physical and chemical methods [4,13,17,18]. Traditionally, the addition of fillers to polymers is an inexpensive way to stiffen the properties of the base material [19]. For example, polypropylene has been modified by many fillers and elastomers to improve its toughness, stiffness, and strength balance, depending on the particular application [20,21]. However, higher biopolymer costs limit their feasibility. In this case, we are using corncobs as a reinforcement to prepare bio-composites with good ratio of price to performance, where corncobs are an agricultural byproduct of lignocellulosic nature.

Several efforts to prepare the bio-composite materials are disclosed in the following patents. U.S. Pat. No. 6,029,395 to Morgan discloses a biodegradable mulch mat. U.S. Pat. No. 5,948,706 to Riedel et al. discloses a fiber composite material and method of manufacture. U.S. Pat. No. 5,635,123 and 5,593,625 to Riebel et al. discloses bio-composite material and method of making. U.S. Pat. No. 6,548,081 to Sadozai et al. discloses bio-absorbable composites of derivatized hyaluronic acid and other biodegradable, biocompatible polymers. U.S. Pat. No. 7,183,339 to Shen et al. discloses the method for making dimensionally stable composite products from lignocelluloses. U.S. Pat. No. 6,855,182 to Sears discloses lignocellulose fiber composite with soil conditioners. U.S. Pat. No. 6,758,996 to Monovoukas et al. discloses cellulose-reinforced thermoplastic composite and methods of making same. U.S. Pat. No. 6,365,077 to Pott et al. discloses process for preparing cellulosic composites. U.S. Pat. No. 6,362,330 to Simon et al. discloses polysaccharide-based thermoplastic material, process for preparing the same and method of use thereof. U.S. Pat. No. 6,346,165 to Markessini et al. discloses method for production of lignocellulosic composite materials. U.S. Pat. No. 4,484,026 to Dunn-Coleman et al. discloses composite process for the production of mushroom cultivation substrates. U.S. Pat. No. 5,948,706 to Riedel et al. discloses a fiber composite material and method of manufacture. U.S. Patent Application No. 2004/0249065 to Schilling et al. describes chemically treated materials such as corncob and protein binders.

Corn is one of the most widely planted crops in the world. The corncobs are the by-product generated during processing of corn. The U.S. Department of Agriculture and Department of Energy have estimated that the U.S. has the resource potential to produce over 1 billion tons of biomass annually and the corncob is one of the largest sources of available biomass in the corn-processing industry. A corncob based fillers/fibers filled plastics can lead to new value-added, non-food uses of agricultural materials. In addition, if a corncob filler can be used effectively; considerable reinforcement of the plastic can be achieved to enhance the mechanical properties of the composite during its useful lifetime.

It is important to point out that it is anticipated there will be a total replacement of conventional based fillers/fibers with agricultural based fillers/fibers. These inexpensive agricultural residues can develop their own niche in the plastics filler/fiber market in the future.

### OBJECTS

It is an object of the present invention to provide an improved biocomposite material comprising corncob granule filler. Further, it is an object of the present invention to provide a biocomposite of a polymer and corncob granules with improved mechanical properties. Further, it is an object to produce a less expensive and potentially biodegradable composite material.

These and other objects will become increasingly apparent by reference to the following description and drawings.

### SUMMARY OF THE INVENTION

The present invention provides a composite composition which comprises: a synthetic polymer; and corncob granules which have been modified so as to be compatible with the polymer to form the composition. In further embodiments, the corncob granules have been modified with a chemical which reacted with the hydroxyl groups on the granules. In further embodiments, the corncob granules have been modified by UV-ozone or plasma treatment of the corncob granules. In further embodiments, the corncob granules have been modified by mechanical modification with high-frequency ultrasound. In still further embodiments, the polymer is biodegradable. In still further embodiments, the polymer is polylactic acid (PLA). In further still embodiments, the chemical is a silane, maleic anhydride grafted polylactic acid (PLA), maleic anhydride grafted polyhydroxyalkanoate (PHA), maleic anhydride grafted polyolefin, maleic anhydride grafted rubber, unsaturated polyester, epoxy or isocyanate. In still further embodiments, the polyolefin is polypropylene (PP), polyethylene (PE) or copolymers thereof. In further embodiments, the composite has been extruded. In further embodiments, the composite composition has been extruded, pelletized and then injection molded. In further embodiments, the corncob granules have been expanded in an AFEX ammonia process, wherein the ammonia reacts with the granules. In still further embodiments, the granules are up to about 80% by weight of the composition. In further still embodiments, the corn cob granules have been modified with gaseous ozone. In further embodiments, the corn cob granules have been modified with organosolvent. In further still embodiments, the corn cob granules have been modified by reaction with an alkali metal hydroxide. In still further embodiments, the corn cob granules have been modified by UV-ozone or plasma treatment in the presence of an aqueous silane.

The present invention relates to a process of a composite composition comprising: a synthetic polymer and corncob granules which have been modified to be compatible with the polymer, which comprises: blending at elevated temperatures, the polymer so as to be thermoplastic and the corncob granules to form the composite composition. Preferably, the blending is by extrusion. Further, wherein the corncob granules have been modified with a chemical which reacted with the hydroxyl groups on the granules. Still further, the corncob granules have been modified by UV-ozone or plasma treatment of the corncob granules. Further still, the corncob granules have been modified by mechanical modification with high-frequency ultrasound. Further, the polymer is biodegradable. Still further, the polymer is polylactic acid (PLA). Further still, the chemical is a silane, maleic anhydride grafted polylactic acid (PLA), maleic anhydride grafted polyhydroxyalkanoate (PHA), maleic anhydride grafted polyolefin, maleic anhydride grafted rubber, unsaturated polyester, epoxy or isocyanate. Further, the polyolefin is polypropylene (PP), polyethylene (PE) or copolymers thereof. Still further, the composite has been extruded, pelletized and then injection molded. Further still, the corncob granules have been expanded in an AFEX ammonia process, wherein the ammonia reacts with the granules. Further, the granules are up to about 80% by weight of the composition. Further still, the corn cob granules have been modified with gaseous ozone. Still further, the corn cob granules have been modified with organosolvent. Further still, the corn cob granules have been modified by reaction with an alkali metal hydroxide. Still further, the corn cob granules have been modified by UV-ozone or plasma treatment in the presence of an aqueous silane.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of photographs illustrating the corncob granules I and II from shelled corncob that were obtained from corn stovers or corncobs respectively.

FIG. 2 is a photograph illustrating corncob granule I (BCRL-20: Biomass Conversion Research Laboratory-20).

FIG. 3 is a drawing showing the major components in plant cell wall.

FIG. 4 is a photograph showing silane-treated corncob granules.

FIG. 5 is a drawing showing a possible reaction between silanol and corncob.

FIG. 6 is a drawing showing a schematic diagram of the AFEX process.

FIG. 7 is a photograph showing AFEX treated corncobs.

FIG. 8 is a photograph showing liquid ammonia treated corncobs.

FIG. 9 is a photograph showing injection-molded composite (PLA/corncob: 70 wt %/30 wt %) samples.

FIG. 10 is a drawing showing a schematic diagram of the extrusion screw.

FIGS. 11A and 11B are graphs showing thermogravimetric curves for untreated and surface treated corncobs.

FIGS. 12A to 12C are SEM micrographs of untreated corncob granule samples: (12A) 200 μm (at 100×), (12B) 200 μm (at 250×), and (12C) 20 μm (at 1000×).

FIGS. 13A to 13C are SEM micrographs of AFEX treated corncob granule samples: (13A) 200 μm (at 100×), (13B) 200 μm (at 100×), and (13C) 20 μm (at 1000×).

FIGS. 14A to 14C are SEM micrographs of liquid ammonia treated corncob granule samples: (14A) 200 μm (at 100×), (14B) 200 μm (at 100×), and (14C) 20 μm (at 1000×).

FIGS. 15A to 15C are SEM micrographs of silane treated corncob granule samples: (15A) 200 μm (at 100×), (15B) 200 μm (at 100×), and (15C) 20 μm (at 1000×).

FIG. 16 is a graph illustrating the flexural properties of the composites, wherein the silane-treated composite has the highest flexural strength.

FIG. 17 is a graph illustrating stress-strain curves of the composites, wherein the silane-treated corncob is the best.

FIG. 18 is a graph illustrating Notched Izod impact strength of the composites, wherein the silane-treated corncob is the best.

FIG. 19 is a graph illustrating temperature dependence of the storage modulus of PLA and PLA based composites.

FIGS. 20A and 20B are SEM micrographs of PLA/untreated BCRL1 (70 wt %/30 wt %) composite: (20A) 200 μm (at 100×), and (20B) 20 μm (at 100×).

FIGS. 21A and 21B are SEM micrographs of PLA/AFEX treated BCRL1 (70 wt %/30 wt %) composite: (21A) 200 μm (at 100×), and (21B) 20 μm (at 1000×).

FIGS. 22A to 22C are SEM micrographs of PLA/ liquid ammonia treated BCRL1 (70 wt %/30 wt %) composite: (22A) 200 μm (at 100×), (22B) 200 μm (at 100×), and (22C) 200 μm (at 100×).

FIGS. 23A and 23B are SEM micrographs of PLA/silane treated BCRL1 (70 wt %/30 wt %) composite: (23A) 200 μm (at 100×), and (23B) 20 μm (at 1000×).

FIG. 24 is a drawing showing chemical reactions involved in maleinized polybutadiene rubber treated corncob.

### DETAILED DESCRIPTION OF THE INVENTION

All patents, patent applications, government publications, government regulations, and literature references cited in this specification are hereby incorporated herein by reference in their entirety. In case of conflict, the present description, including definitions, will control.

The term “synthetic polymer” means a polymer polymerized by reaction of precursors in a reaction vessel included a polymer such as PHA's (such as PHB) provided by bacteria.

The term “PLA” as used herein refers to poly(lactic acid). There are part of a family of polymers derived from glycolides as described in U.S. Pat. No. 6,469,133B2 to Baker et al.

In the present invention, eco-friendly sustainable bio-composite materials have been fabricated from corncobs, one of the most important agricultural residues, and polylactic acid (PLA), one of the most promising biodegradable polymers. The composite compositions were initially produced by a micro-compounding molding system. The enabling technology was developed to transform corncobs into value-added products for biocomposite manufacturing.

Corncobs that remain after grain has been harvested, are widely available in the United States. Corncob is an abundant resource for agro-/bio-fibers/fillers and has potential to replace traditional fiber/filler because of its low ratio of price to performance. The exploration of these inexpensive agricultural residues as bio-resource for making industrial products opens new avenues for the utilization of agricultural residues.

Melt-processing of thermoplastic biodegradable polymers that are highly loaded with cheap biodegradable fillers like corncobs affords both an inexpensive process and materials' cost-savings without sacrificing biodegradability. This invention seeks to demonstrate both the technical feasibility and the commercial viability of using corncobs as a filler in plastic composites, thereby reducing the use of energy-intensive, non-renewable raw materials in plastics manufacturing.

To date, fossil-based petrochemical resources have represented a convenient and seemingly inexhaustible source for energy and industrial compounds. Concern over a variety of environmental issues as well as the nonrenewable nature of petrochemicals has sparked significant interest in renewable sources of biomass fiber. Biomass fiber can often replace imported petrochemicals while providing a sustainable use for land that should be in grass or trees. Recently, natural fiber-reinforced composites are becoming increasingly popular in the furniture, automotive and building industries. Agricultural residues, such as corncobs, can also be exploited as readily available natural fiber resources for similar applications.

This invention presents the results of processing and physical properties of environmentally friendly corncob reinforced PLA composites. PLA, which can open many new opportunities in industrial bio-plastic applications, and there is a need to better understand and describe its properties as the matrix material for bio-composites.

The performance and properties of composite materials usually depend on the properties of the individual components and their interfacial compatibility. To ensure appropriate interfacial interactions their surface properties must be modified accordingly. Corncobs-matrix adhesion was promoted by corncobs surface modifications using the Ammonia Fiber Explosion (AFEX) treatment as well as with a silane coupling agent. The final composites materials have improved physical properties such as modulus at higher temperature, high impact strength, and significantly high flexural properties. The morphology, as indicated by scanning electron microscopy (SEM), showed good dispersion of the corncobs in the PLA matrix. Microstructure studies also indicated a significant interfacial bonding between the matrix and the corncobs. Therefore, it is important to modify the surface of the corncobs in order to improve ease of adhesion with and dispersion within the matrix in order to realize the great potential of thermoplastic matrix composites using corncobs. Overall, the advantages of using a biodegradable polymer like PLA as a matrix was proved since the environmentally friendly composites prepared with this material present good thermal and mechanical properties.

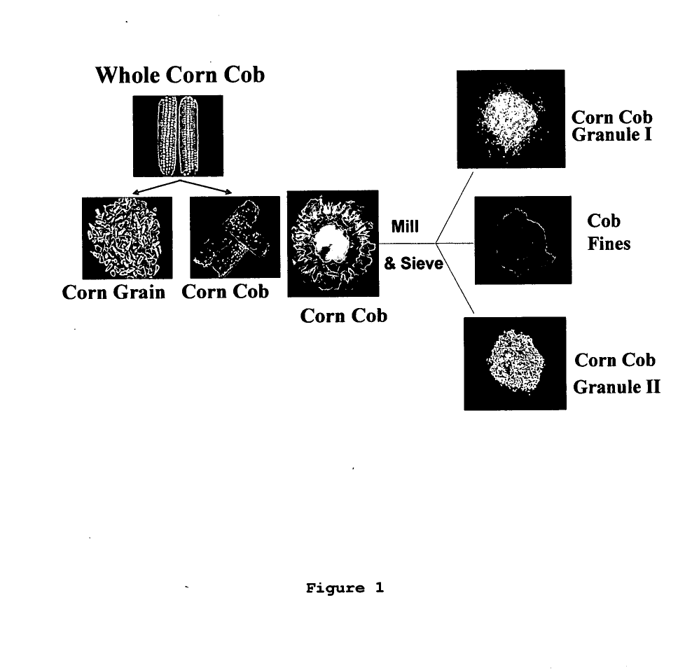

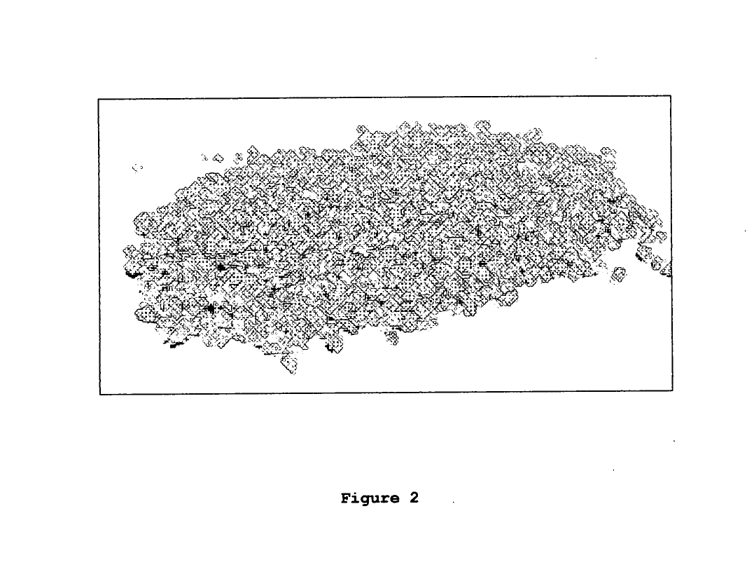

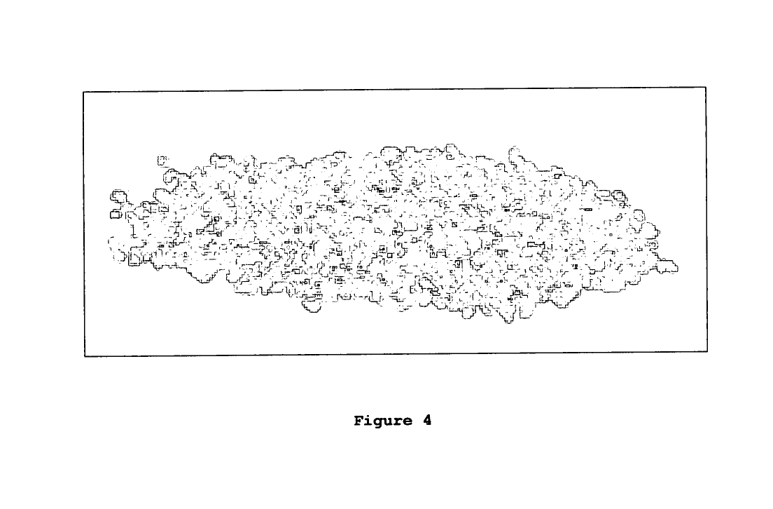

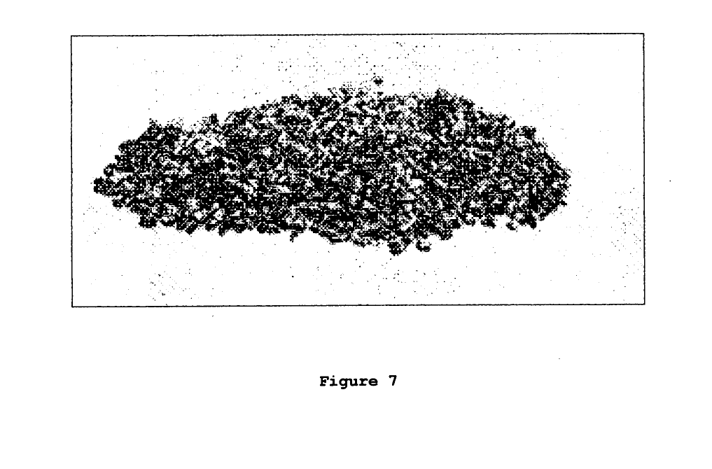

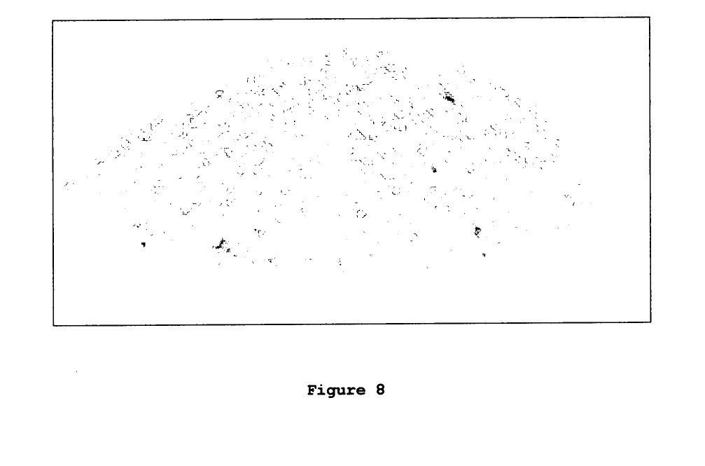

This invention develops the enabling technology needed to transform corncobs into value-added products for bio-composite manufacturing. Corncob granules (FIG. 1, FIG. 2, FIG. 4, FIG. 7 and FIG. 8) (in the following disclosure granules will be referred to generally as corncob) were obtained from corn stovers. Corn stover that remains after grain has been harvested, is widely available in the United States as well as in many regions of the world, and the natural biomass heterogeneity is a challenge to using corn stover as a feedstock.

Agricultural crop residues are the biomass that remains in the field after the harvest of agricultural crops. The most common residues include the stalks, ears, leaves, and/or cobs (collectively referred to as stover), and/or straw associated with wheat production. Corncob is one of the largest sources of available biomass in the corn-processing industry [1]. It is estimated that 222 million tons of corn were produced in 1990 [2]. The yield of corncobs was in excess of 40 million tons [1]. Based on USDA data (2002) for the past four years, average corn production is 245 million t/yr. According to several estimates, the amount of corn stover that can be sustainably collected is 80-110 million dry t/yr. Since the ratio between corn grain and corn cob may reach 100:18, a large quantity of corn cob is generated. That is to say, the resource of corncob is rather abundant. The whole corncob is about 88% grain, 4% cob fines, 6% corn cob granule I and 2% corn cob granule II, as shown in FIG. 1. Unfortunately, very little corncob is being used to produce high value-added products, most of which are discarded as waste. Hence, the need to utilize corncob (the price of this corncob is only 5 cent per lb) as a resource is gaining interest. The use of these inexpensive agricultural residues as bio-resource for making industrial products opens a new avenue for the utilization of agricultural residues. The high cost of biodegradable thermoplastics has prevented their adoption for automotive, building, packaging and other wide-scale applications. The necessary low-cost nature of composite products, especially in the case of composites that are fabricated by using poly(lactic acid) biopolymers, requires both a cost efficient processing system and inexpensive raw materials. This invention shows the technical feasibility and the commercial viability of using corncob (as seen in FIG. 2) as filler in plastic composites, thereby reducing the use of energy-intensive, non-renewable raw materials in plastics manufacturing.

Biodegradable polymers can be obtained from renewable resources, can be synthesized from petro-based chemical or also can be microbial [14] synthesized [22]. One of the most promising biodegradable polymers is poly(lactic acid) (PLA), which can be derived from renewable resources, such as corn [22]. Composites containing biodegradable thermoplastic polymers, e.g., PLA, and wood fibers offer an interesting combination of properties, as well as lower cost than competitive materials. PLA is a linear aliphatic thermoplastic polyester produced from a lactic acid by-product obtained from the fermentation of corn dextrose [22]. The Nebraska facility of Cargill Dow is capable of producing up to 300 million pounds (140,000 metric tons) of PLA per year, using 40,000 bushels of corn per day [23], and production is expected to more than triple to one billion pounds by 2007 [24]. PLA is well known for its highly biocompatible and biodegradable nature [22] and has received considerable industrial attention for use as commodity resins, capable of replacing petrochemical-based polymers. PLA has better mechanical properties than polypropylene (PP). Pure PLA has a tensile strength of 62 MPa and a modulus of 2.7 GPa in contrast to 36 MPa and 1.2 GPa for pure PP [25]. Moreover, PLA can be processed by injection molding, blow molding, and film forming; because the glass transition temperature (T_{g}) of PLA is 59° C. and the melting temperature (Tₘ) is 172° C. [26,27]. Oksman et al. [7] showed that PLA-flax composites had better mechanical properties than PP-flax composites. Although PLA has mechanical properties suited for industrial plastic applications [23,25,27] it is considered too brittle for many commercial applications. It is however possible to overcome brittleness and poor processability of stiff and hard polymers, by combining them with other materials. Most research on PLA composite ultimately seeks to improve the mechanical properties to a level that satisfies a particular application [3,23]. A relative easy way to improve the mechanical properties of a polymer is the addition of fibers or filler materials. Some researchers consider the enhanced toughness the main advantage of biofibers in composites [3,26,27]. Since both components of the composite, biopolymer (e.g., PLA) and biofibers, are biodegradable, the composite as the integral part is also expected to be biodegradable [4,5,28]. Hence, since PLA can open many new opportunities in industrial bioplastic applications, there is a need to better understand and describe its properties as the matrix material for bio-composite materials.

In the present invention, eco-friendly sustainable bio-composite materials were successfully fabricated from corncobs, one of the most important agricultural residues, and polylactic acid (PLA) that were produced by a micro-compounding molding system. The major benefit would be the development of new markets for biomass products that offset the use of petroleum-based plastics in plastics manufacturing.

Though interest in bio-fiber composites for industrial applications in advanced countries has increased significantly, the lack of availability of extensive property data is an important contributing factor limiting the wide spread application of bio-fibers in composites. The main purpose of this invention is to investigate the properties and processing of corncob as reinforcement for bio-composites, which have a potential to replace glass in many applications that do not require very high load bearing capabilities.

The current invention focuses on larger scale extrusion compounding of biodegradable plastic and other common thermoplastics composites where the corncob as a reinforcement material to form corncob based bio-composites along with processing temperature below 200° C. All of the components, including plastic and surface treated as well as untreated corncobs, were fed into an extruder and under optimum processing conditions for the fabrication of corncob reinforced bio-composites, and then finally the extruded composite specimens were molded into flex- and tensile-coupons using the injection molding technique, which is widely employed in industry. The interface between hydrophilic natural fibers and hydrophobic biopolymer is weak because of the natural incompatibility of the two phases and strong fiber-fiber interactions resulting from hydrogen bonding [29]. Chemically modified corncobs were used to overcome this problem.

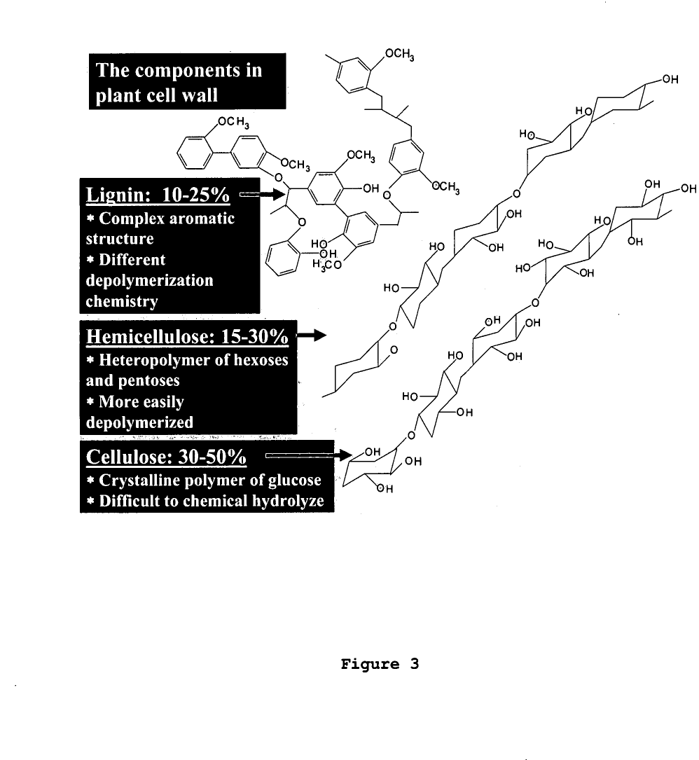

Corncobs were selected as the cellulose source because corncobs are considerably rich in cellulose and hemicellulose (approximately 800 g/kg dry matter) [30]. Corncob is similar to natural/wood fiber/filler and could also be considered as a natural composite material. Cellulose, hemicellulose, and lignin comprise the three major components that can serve as reinforcement (FIG. 3). Because cellulose, lignin and hemicelluloses form strong linkages, PLA-corncobs blends produce bio-composites with good performance properties. Melt-processing (i.e. extrusion and injection molding) of thermoplastic biodegradable polymers that are highly loaded (with cheap biodegradable fillers like corncobs) affords both an inexpensive process and materials' cost-savings without sacrificing biodegradability. Corncob is an abundant resource for agro-/bio-fibers/fillers and has potential to replace traditional fiber/filler because of its low ratio of price to performance. Moreover, the one of the important advantages of incorporating corncobs into thermoplastics (e.g., PLA) is lower materials costs, which could reduce the total cost of the composites.

### EXAMPLE 1

The following steps were fabricated biocomposites from corncobs and corn-based plastic, PLA.

1. Corncob granules (Granule I) (the experimental product name was BCRL-20): Biomass Conversion Research Laboratory-20) is a byproduct from corn stover. The corn stover was milled using a regular mixer for 10 minutes, and sieved for another 10 minutes using different mesh size screens. The material collected on the 10 and 20-mesh screen is called corncob. This material occupies 10% of the whole corn stover on the weight basis. Moreover, corncob granules (Granule II) of about 14 to 20 mesh (U.S. Standard Screen sizes with sieve openings of 1.41 mm to 0.84 mm), or larger, were obtained by hammer milling the corncobs, after removing the kernel/grains from it. The granules were separated from the finer, lighter husk portion by aspiration. During the process of grinding and sieving corn stover, we found some corncob granular material (called BCRL-10), which was tough to grind. This occupies about 10% of the whole corn stover. This material was recalcitrant to enzymatic hydrolysis. When we did a composition analysis on this sample and found that it had higher of hemicellulose content compared to corn stover. Subsequently we took the whole corn plant and started fractionating different parts and found that this BCRL-10 came from corncob.

2. Corncobs surface modification: The performance and properties of composite materials usually depend on the properties of the individual components and their interfacial compatibility. To ensure appropriate interfacial interactions their surface properties must be modified accordingly. One difficulty that has prevented a more extended utilization of the plant/natural cellulosic fibers/materials is the lack of good adhesion to most polymeric matrices. The hydrophilic nature of plant/natural cellulosic fibers/materials adversely affects adhesion to a hydrophobic matrix and as a result, it may cause a loss of strength. To prevent this, the plant/natural cellulosic fibers/materials surface has to be modified in order to promote adhesion. It is generally known that the interfacial shear strength between plant/natural cellulosic fibers/materials and a thermoplastic matrix has been improved by the silane chemical modification of the fiber surface [31]. Several surface treatment methods have been used to improve the corncob-matrix interfacial bonding that are as follows:

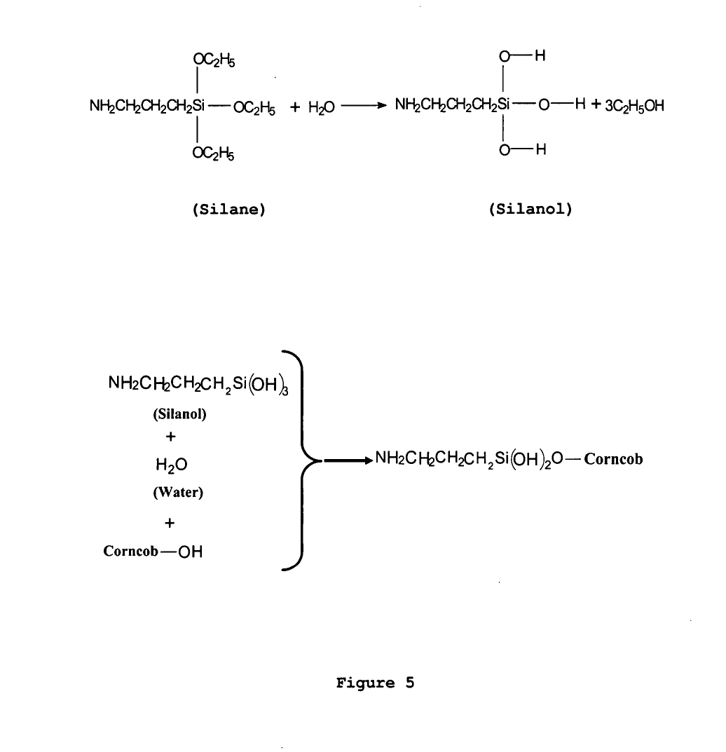

(i) Silane treatment of the corncobs: For the surface treatment of the corncobs (FIG. 4), 5 wt % silane (3-Aminopropyltriethoxysilane) (weight percentage regarding the corncob) was dissolved for the hydrolysis in a mixture of water-ethanol mixture (40:60 w/w) (FIG. 5). The pH of the solution was adjusted to 4 with acetic acid and stirred continuously during 1 hr. Then, the corncobs were soaked in the solution and left for 5 h. Corncob granules were washed and then the fiber was kept in the air for 3 days. At last, the fibers were dried in oven at 80° C. for 12 h. Silane reacts with water to form silanol and alcohol. The silanes have methoxy groups that hydrolyze in water or a solvent. Once they hydrolyze, the methoxy groups are converted to hydroxyl groups, which are very reactive. 3-Aminopropyltriethoxysilane has 3 methoxy groups, which on hydrolysis are converted to hydroxyl groups. The hydrolyzed silanes are called silanols. Then silanol reacts with the OH group of the corncob which forms stable covalent bonds to the cell wall that are chemisorbed onto the corncob surface (FIG. 5).

The hydroxyls on the silanols can undergo a condensation reaction, with hydroxyl groups on the surface of the corncob, thereby linking to the corncob through the siloxane bonds. The silanols are also capable of linking with the matrix polymer through the siloxane bonds. Thus, the silanes act as connector molecules between the matrix and the corncob. Silane treated corncob granules (FIG. 4) were placed in sealed polyethylene bags for further processing.

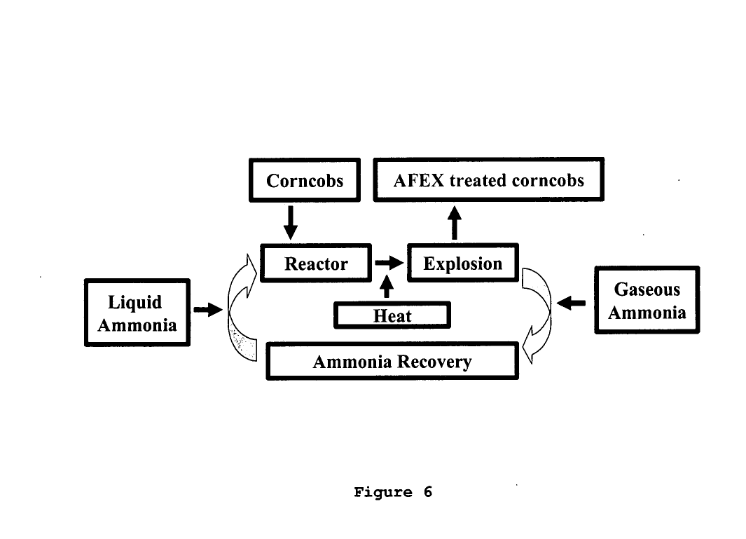

(ii) Ammonia Fiber Explosion (AFEX) treatment of the corncobs: A unique physiochemical pretreatment referred to as Ammonia Fiber Explosion (AFEX) offers potential as a pretreatment for lignocellulosic material [32,33]. FIG. 6 illustrates the schematic diagram of AFEX process. In AFEX pretreatment biomass is treated with liquid anhydrous ammonia at temperatures (25-200° C.) and high pressure (100-800 psi) for 5 min. Then the pressure is rapidly released. In this process, nearly all of the ammonia can be recovered and reused while the remaining serves as nitrogen source for microbes, in downstream processes. AFEX is basically a dry to dry process. Treated biomass is stable for long periods. Cellulose and hemicellulose are well preserved in the AFEX process, with little or no degradation. The hard corncob based granules were AFEX treated at optimum corn stover AFEX conditions of 90 degrees Celsius, 1:1 (w/w) liquid ammonia to dry biomass loading and treated for 5 mins. The treated corncob granule samples were removed (FIG. 7) and allowed to stand overnight in a fume hood to evaporate the residual ammonia.

(iii) Liquid ammonia treatment of the corncobs: Liquid ammonia treatments have been of interest for improving the hand of cellulosic fabrics for about twenty years [34]. Liquid ammonia is effective at improving the strength, shrink resistance, and hand of cellulosic fabric [35]. In this study, we applied a liquid ammonia (NH₃) treatment to the corncobs (FIG. 8) and subsequently processed them with hot water and dry heat.

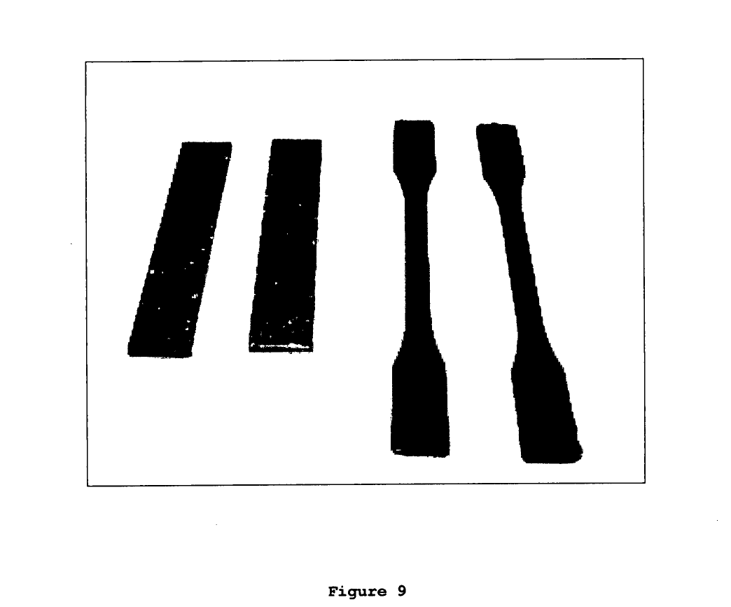

3. Prior to processing, the corncobs and PLA were dried under vacuum at 80° C. for 24 h. The required amount of the corncobs and the PLA were mechanically, and then the samples were extruded at 150 rpm with a Micro 15 cc compounding system (DSM Research, Geleen, The Netherlands) at 183° C. for 10 minutes. The extruder has a screw length of 150 mm, an L/D of 18, and a net capacity of 15 cm³. In order to obtain the desired specimen samples for various measurements and analysis, the molten composite samples were transferred after extrusion, through a preheated cylinder to a mini-injection molder, which was pre-set with injection temperature at 183° C. and mold temperature at 40° C. Injection-molded samples (FIG. 9) were placed in sealed polyethylene bags in order to prevent moisture absorption.

### EXAMPLE 2

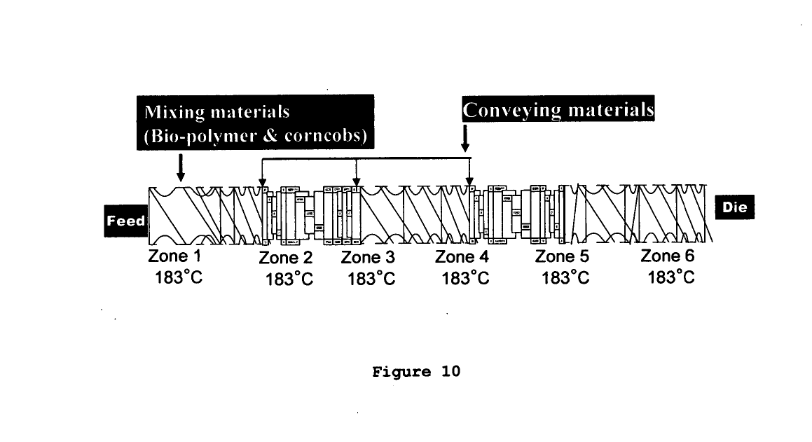

Corncob based bio bio-composites were prepared by using a standard industrial scale or lab scale extruder (such as ZSK-30 Werner and Pflider (WP) Twin-screw Extruder), (FIG. 10) and the desired parts were made by using injection molding. The corncobs and bio-polymer matrix resin, mixed at a ratio of 50 wt % or 50 wt %, were fed into a ZSK-30 WP twin-screw extruder with an L/D of 30. A uniform temperature of 183° C. was maintained for all the six zones of the extruder. The PLA matrix resin was fed at 46.5 g/min, while the corncobs were fed through a side feeder at a rate of 20 g/min.

The screw speed was set at 100 rpm. The first three minutes of the extrudate was discarded and then the strands of the extrudate were collected and chopped to form pellets using a pelletizer.

### EXAMPLE 3

The current invention can also provide the methods how to prepare corncob reinforced composites with different matrices besides PLA.

A polypropylene (PP) based composite was made using the twin-screw extruder of Example 2. Compounding were carried out at a screw speed of 100 rpm and extruder temperatures were set at 180° C. (zone 1 to zone 3), 183° C. (zone 4), 184° C. (zone 5) and 185° C. (zone 5). A pelletizer was used to chop the strands into pellets, and then the pelletized composite specimens were molded into tensile coupons using the injection molding.

Corncob based PLA composites were tested for mechanical properties (e.g., flexural modulus, impact resistance) and thermo-mechanical properties (e.g., dynamic mechanical properties). Corncob-matrix adhesion was promoted by corncob surface modifications using the Ammonia Fiber Explosion (AFEX) treatment as well as with the silane coupling agent. The final composites materials have improved physical properties such as modulus at higher temperature, high impact strength, and significantly high flexural properties. It was necessary to modify the surface of the corncob in order to improve ease of adhesion with and dispersion within the matrix in order to realize the great potential of thermoplastic matrix composites.

Fourier Transform Infared (FTIR) analysis: The composition of the corncob, as measured by NREL, was 33.5% glucan, 27.5% xylan, 2.4% arabinan, 1.0% galactan, 0.69% mannan, 12.5% lignin, 1.8% protein, 4.5% uronic acid, 4.5% acetyl, 2.2% extractives and 3.7% structural inorganic on a dry weight basis (Table 1). Whereas the composition of the pine wood was 37.7% glucan, 4.6% xylan, 7.0% mannan, 27.5% lignin, and 10.8% extractives according to Hayn et al. [36]. Corncob contains 38% cellulose and 32% hemicellulose. Xylans appear to be the major interface between lignin and other carbohydrates [36]. Lignin is a complex, hydrophobic, cross-linked aromatic polymer. Lignin is less in the case of corncob when compared with wood.

TABLE 1
The composition analysis was done at NREL using a FTIR technique.

| | | | | | | Lignin | Struc. | Ext. | | | Uronic |
|---|---|---|---|---|---|---|---|---|---|---|---|
| Sample | Glucan | Xylan | Galactan | Arabinan | Mannan | P_cor | inorg | inorg. | Protein | Acetyl | acid |
| Uncut Corn | 32.58 | 23.44 | 1.37 | 2.74 | 0.26 | 12.27 | 3.57 | 2.74 | 3.13 | 3.14 | 3.74 |
| stover | | | | | | | | | | | |
| Corncob | 33.45 | 27.52 | 1.02 | 2.35 | 0.69 | 12.46 | 3.70 | 2.17 | 1.75 | 4.49 | 4.49 |

High resolution electron spectroscopy (ESCA) analysis: The binding energy values were. determined using ESCA for the uncut corn stover and corncob samples (Table 2). The oxygen to carbon ratio increases in corncob granule samples, which indicates it is richer in carbohydrates on the surfaces.

TABLE 2
High resolution electron spectroscopy
(ESCA) for chemical analysis results.

| | 284 | 286 | 288 | 531 | 532 | |
|---|---|---|---|---|---|---|
| | ev | Ev | ev | ev | ev | |
| | (binding | (binding | (binding | (binding | (binding | C/O |
| Samples | energy) | energy) | energy) | energy) | energy) | ratio |
| Uncut | 77.25 | 17.70 | 5.05 | 27.00 | 73.00 | 0.23 |
| corn | | | | | | |
| stover | | | | | | |
| Corncob | 68.99 | 24.32 | 6.80 | 22.01 | 77.99 | 0.26 |

X-ray photon spectroscopy (XPS) analysis: X-ray photon spectroscopy (XPS) survey scans were taken for untreated as well as surface-treated corncob granules. These scans revealed the presence of carbon, oxygen, and nitrogen in the untreated corncobs. Table 3 shows the elemental composition of the corncobs. It is observed that after AFEX treatment the carbon and nitrogen content increases, while oxygen contents decrease. After liquid ammonia treatment, there is an increase in carbon content, and a decrease in carbon and nitrogen contents. Again, after treatment with the silane, there is a presence of silicon, as well as there is an increase in nitrogen, while a decrease in carbon and oxygen contents, when comparing with the untreated corncob granule sample.

TABLE 3
Elemental composition of surface-treated corncob
granules (from X-ray photon spectroscopy)

| | C | O | N | Si |
|---|---|---|---|---|
| | 1s | 1s | 1s | 2p |
| Samples | [0.314] | [0.733] | [0.499] | [0.368] |
| Untreated corncob | 76.08 | 21.98 | 1.95 | — |
| AFEX treated corncob | 79.31 | 18.21 | 2.48 | — |
| Liquid ammonia | 77.97 | 20.16 | 1.87 | — |
| treated corncob | | | | |
| Silane treated | 73.91 | 21.01 | 3.64 | 1.45 |
| corncob | | | | |

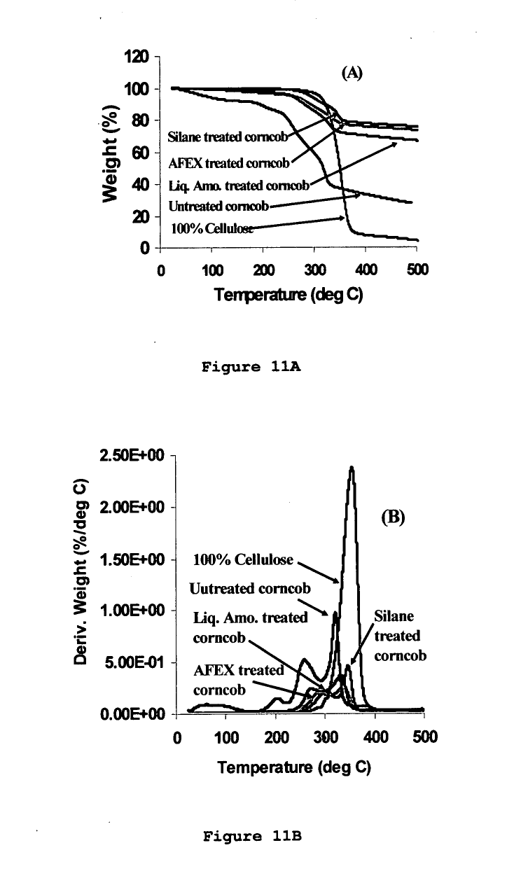

Thermogravimetric analysis: Thermogravimetric curves for untreated and surface treated corncobs are shown in FIGS. 11A,B. Table 4 summarizes the maximum decomposition temperatures for untreated- and surface treated-corncobs. At 76° C., there was 5% loss in weight of untreated corncob. Up to 287° C., there was less than 5% loss in weight of surface-treated corncobs. After the silane treatment, the temperature at the maximum rate of decomposition of corncob increased significantly, indicating that the silane treatment leads to an enhancement in the thermal stability of the corncob granule. Weight loss of 10% occurred between 179 and 312° C. for the untreated and surface-treated corncobs, while a weight loss of 20% occurred in the range of 247-351° C., and weight loss of 30% was observed in range of 268 to >597° C. for untreated and surface-treated corncob granules.

TABLE 4
Thermogravimetric data for untreated-
and surface treated- corncob granules.

| | Temperature (° C.) | | | | Max. |
|---|---|---|---|---|---|
| | 5% | 10% | 20% | 30% | degradation |
| | weight | weight | weight | weight | temperature |
| Materials | loss | loss | loss | loss | (° C.) |
| Untreated | 76 | 179 | 247 | 268 | 321 |
| corncob | | | | | |
| AFEX treated | 232 | 286 | 336 | >597 | 333 |
| corncob | | | | | |
| Liq. Amo. | 247 | 276 | 319 | 371 | 331 |
| treated | | | | | |
| corncob | | | | | |
| Silane | 287 | 312 | 351 | >597 | 350 |
| treated | | | | | |
| corncob | | | | | |

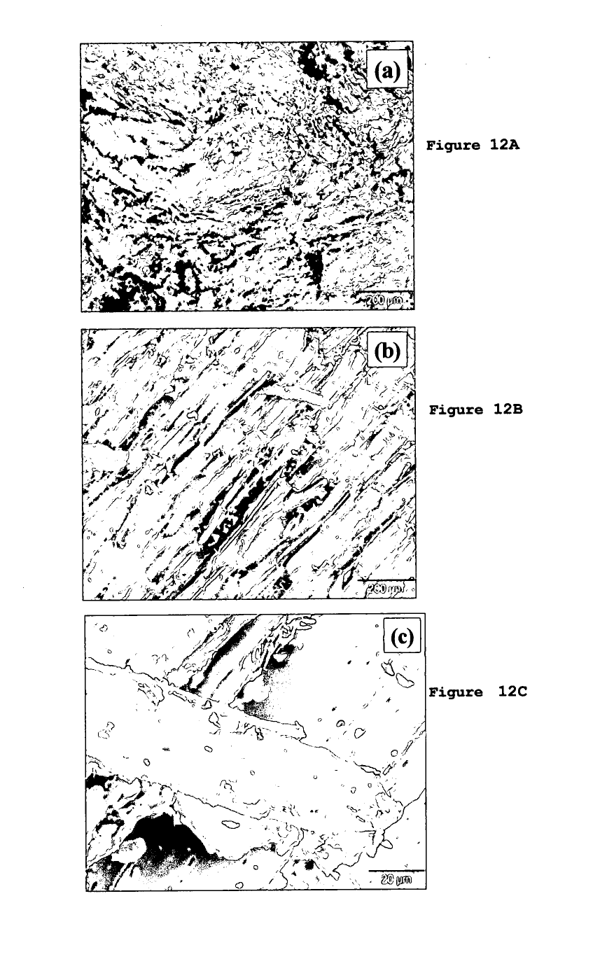

The morphological studies of the untreated- and treated-corncob granule samples: The morphology of untreated- and treated-corncob granule samples was observed by scanning electron microscope (SEM) at room temperature. The morphology of corncob granule was investigated by SEM as shown in FIG. 12. As seen in FIGS. 12A to 12C, these are minute pores on the surface of the corncob granule. The porous surface morphology is useful for better mechanical interlocking with the matrix during composite processing.

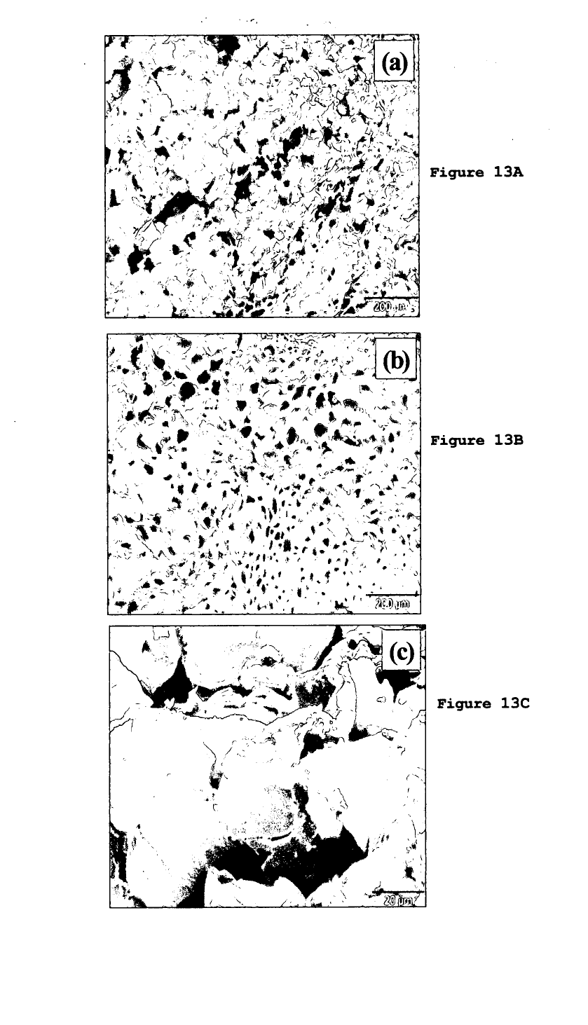

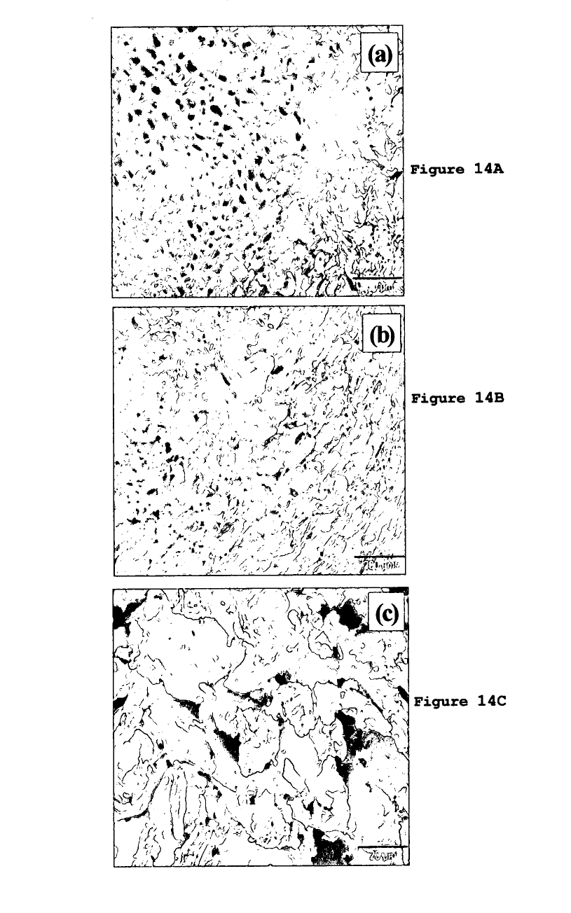

FIGS. 13A to 13C show the morphology of AFEX treated corncob granule samples. In FIGS. 14A to 14C, the pores became more prominent upon AFEX treatment. The pores were found to have an average diameter of 10 μm, and these minute pores promote better mechanical anchorage between BCRL and matrix.

As seen in FIGS. 14A to 14C, the liquid ammonia treated corncob samples show that the corncob granule surface is rough, exhibiting groove-like structures on its surface. The distribution of the pores of different size was observed.

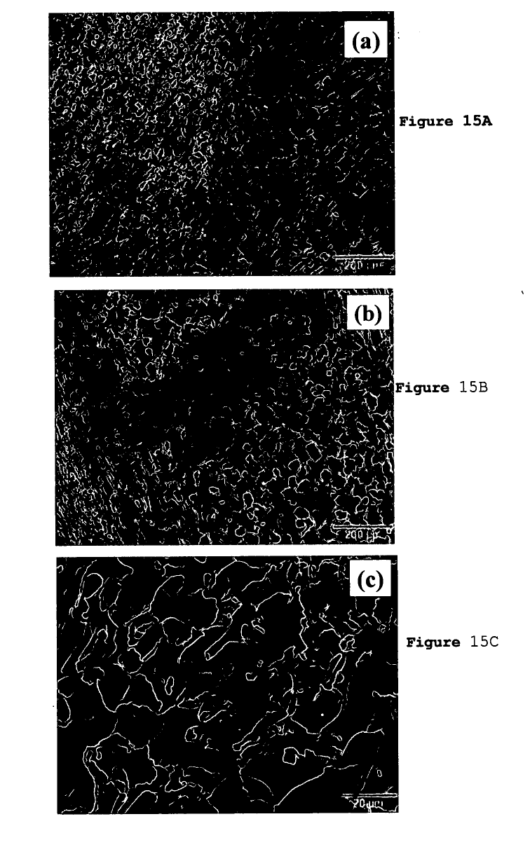

There is strong evidence that physical microstructure changes occurred at the fiber surface as seen in FIGS. 15A to 15C. It can be clearly observed that the silane treated corncob granule surface shows the difference when compare the liquid ammonia treated and untreated fibers. Large number of micropores could be seen on the surface that having an average diameter of 8 μm. Since the corncob granules exhibited micropores on its surface, the silane penetrated into the pores and formed a mechanically interlocked coating on its surface.

Effect of surface treatments on the mechanical and physico-mechanical behaviors of biocomposites: The fully environmentally friendly corncob granule-reinforced PLA composites were successfully fabricated and developed. The present invention focused on determining the ideal processing conditions and supplementary materials for the development of the inexpensive agricultural residue based biocomposite materials. The biocomposite materials were tested for their mechanical and physico-mechanical properties.

Mechanical Properties.

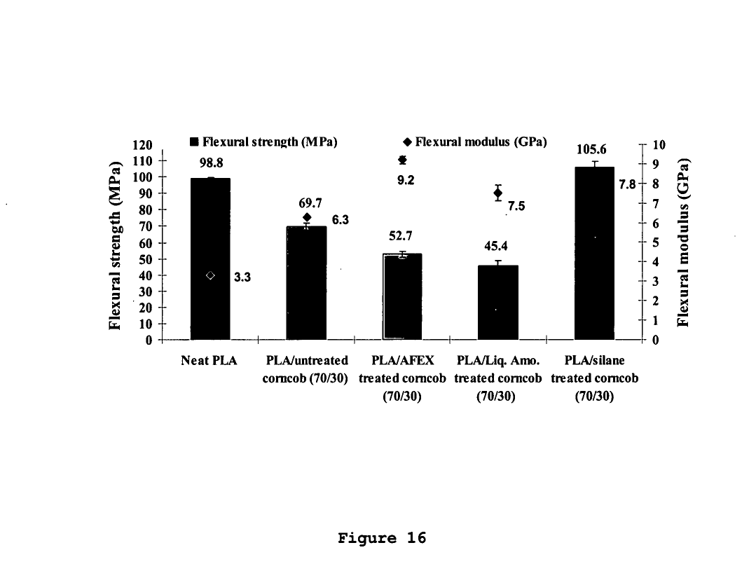

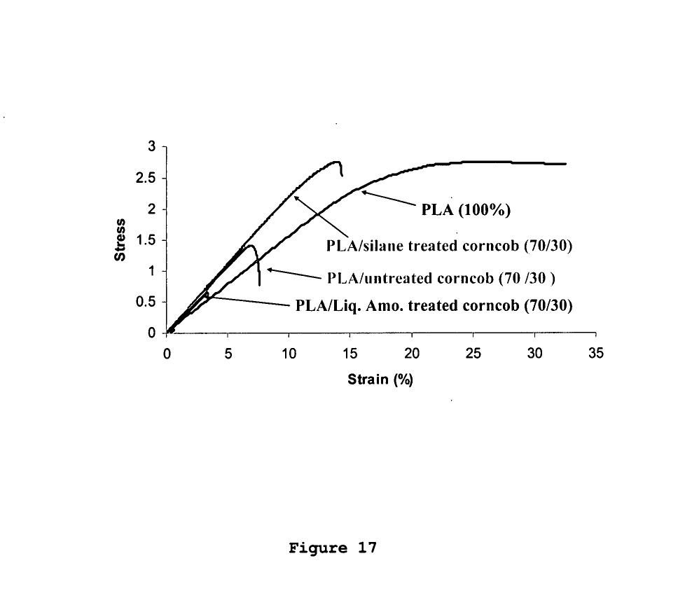

1. Flexural properties of the composites: The flexural strength and modulus of the composites are summarized in Table 5 and FIG. 16. Comparison between the averaged flexural stress-strain curves of the untreated and treated corncobs reinforced composites (with 30 wt % corncob content) along with the PLA matrix alone is informative (FIG. 17). As seen in FIG. 17 and Table 5, the modulus of PLA composites increase significantly with the addition of the corncobs, though the flexural strength of the PLA composites decreased in the presence of corncobs. It was also found that the flexural modulus improves significantly when AFEX- and silane-treated corncobs were used than that of untreated versions. When corncobs are treated by silane, the strength of the composites became higher than that of untreated versions due to the intrinsically increased strength of the corncobs and manifesting a better interfacial bond between the corncob and the matrix.

TABLE 5
Flexural properties of the composites.

| | Flexural | Flexural | Improvement |
|---|---|---|---|
| PLA/corncob | Strength | Modulus | (Modulus) |
| (wt %) | (MPa) | (GPa) | (%) |
| PLA (100%) | 98.8 ± 0.9 | 3.3 ± 0.1 | — |
| PLA/untreated corncob | 69.7 ± 2.2 | 6.3 ± 0.0 | 90 |
| (70/30) | | | |
| PLA/AFEX treated corncob | 52.7 ± 1.7 | 9.2 ± 0.2 | 178 |
| (70/30) | | | |
| PLA/Liq. Amo. treated | 45.4 ± 3.5 | 7.5 ± 0.4 | 127 |
| corncob (70/30) | | | |
| PLA/silane treated corncob | 105.6 ± 3.8 | 7.8 ± 0.0 | 136 |
| (70/30) | | | |

In the case of 30 wt % corncob content, the flexural strength is increased from 69.9 MPa for the untreated corncobs to 105.6 MPa for the silane-treated corncobs, that is, a 51% increase. Moreover, the flexural modulus is increased from 6.3 GPa for the untreated corncobs to 9.2 GPa for the AFEX treated corncobs, that is, a 46% increase. The composite with 30 wt % silane-treated corncob contents exhibited the best flexural properties. PLA has a high flexural strength and it was difficult to reinforce the strength of PLA. According to Shibata et al. [37], though flexural moduli increased for PLA composites, flexural strength did not increase regardless of the fiber treatment. Generally, the silane treated natural fiber reinforced biocomposite was observed to show an increase in nucleation density compared with the composite with the untreated fibers under the same conditions [38]. The increased nucleation has provided smaller crystals that result in a transcrystalline interphase region, with improved bonding between the natural fiber and the matrix [39].

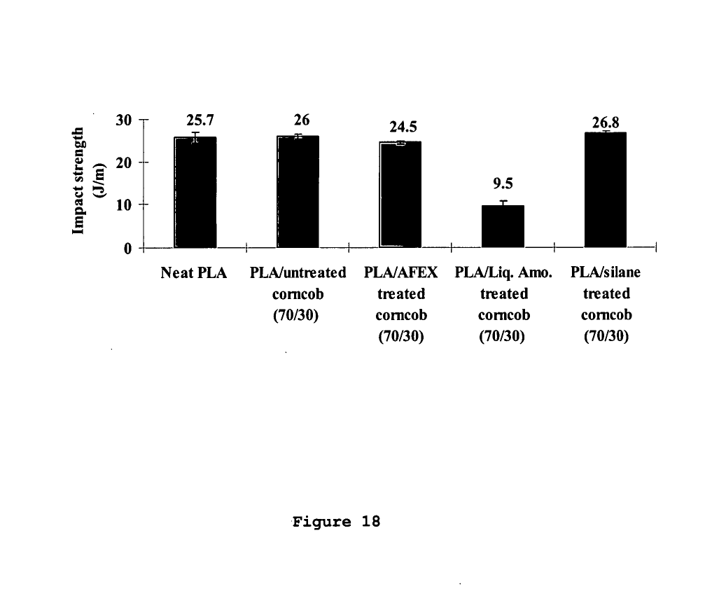

2. Notched Izod impact strength of the composites: The impact strength of corncob reinforced PLA composites was found to increase in the presence of untreated corncob as well as for silane treated corncob as seen in FIG. 18. These impact strength properties of untreated corncob- and silane treated corncob-reinforced PLA composites were higher than those of the PLA matrix itself. In the presence of silane treated corncob, the impact strength of the composite improved 4.2%, which may be related to the better interfacial adhesion between matrix polymer and corncob. Generally, the impact properties of composite materials are directly related to its overall toughness, where impact strength illustrates the ability of a material to resist the fracture under stress applied at high speed. The high toughness of this biocomposite places it in the category of a tough engineering material. Several studies have been reported on the impact behavior and factors affecting the impact strength of composite materials [40,41]. It is well known that the impact response of biocomposites is highly influenced by the interfacial bond strength, the matrix and bio-fiber properties.

Thermo-Mechanical Properties.

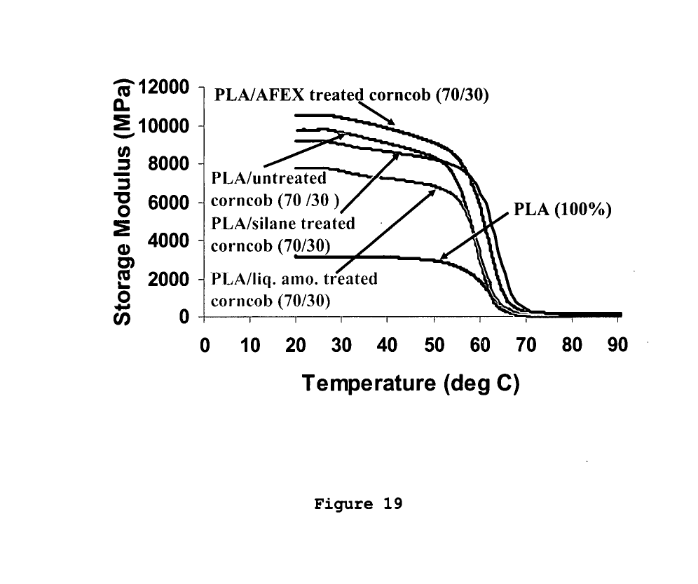

Dynamic mechanical properties: FIG. 19 shows dynamic storage modulus of the PLA and PLA based composites, as a function of temperature, respectively. Storage modulus of all untreated- and treated-corncob reinforced PLA based composites increased significantly when compare with neat PLA matrix. AFEX-treated corncob reinforced PLA based composite showed significantly high storage modulus when compare with untreated corncob reinforced composite. It is clear from FIG. 19 and Table 6 that the storage modulus of corncob reinforced PLA based composite is higher than that of PLA matrix. This is due to the reinforcement imparted by the corncobs that allows stress transfer from the matrix to the corncobs [34].

TABLE 6
The thermo-mechanical properties of the PLA and PLA based composites.

| | | | | Storage Modulus | |
|---|---|---|---|---|---|
| | Glass transition | | | (GPa) | Reinforcement |
| | temp. (T_{g}) (obtained | Storage Modulus | Storage Modulus | at 60° C. | imparted by the |
| PLA/corncob | from loss modulus | (GPa) | (GPa) | (near T_{g} of the | corncob at 25° C. |
| (wt %) | curves (° C.) | at 25° C. | at 40° C. | PLA sample) | (modulus) (%) |
| PLA (100%) | 63 | 3.2 | 3.1 | 1.8 | — |
| PLA/untreated | 68 | 9.8 | 9.0 | 2.6 | 206 |
| corncob (70/30) | | | | | |
| PLA/AFEX treated | 65 | 10.4 | 9.8 | 5.7 | 225 |
| corncob (70/30) | | | | | |
| PLA/liq. amo. treated | 65 | 7.7 | 7.2 | 3.2 | 140 |
| corncob (70/30) | | | | | |
| PLA/silane treated | 64 | 9.2 | 8.6 | 6.6 | 187 |
| corncob (70/30) | | | | | |

It is possible to see in FIG. 19 that thermal properties of PLA are increased with the incorporation of corncobs. The softening temperature is increased form about 48° C. for pure PLA to 57° C. with corncobs (specially in the case of silane treated corncobs) and it is further increased if the composite is crystallized [35]. These DMA results show important variations of main relaxation temperature, which can be linked both, to interactions resulting in a decrease of chain mobility and to a regular reinforcing effect. These results are consistent with the static mechanical behavior, which vary according to the corncob content (up to 30 wt %, in this case), and corncob nature (treated or untreated). Thus from all the mechanical and thermo-mechanical aspects studied, this confirms that the interfacial adhesion between the fiber and the matrix is greater in the treated corncob reinforced PLA composite.

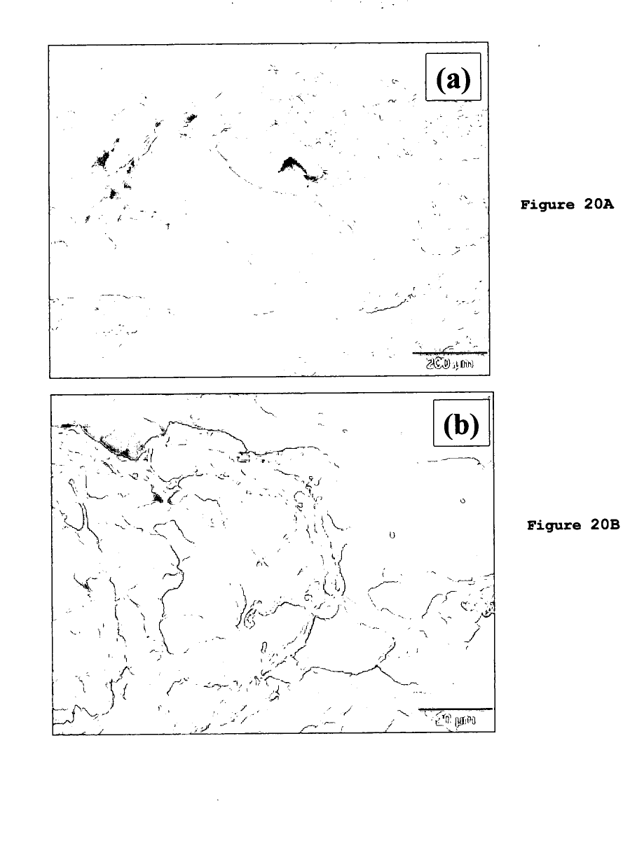

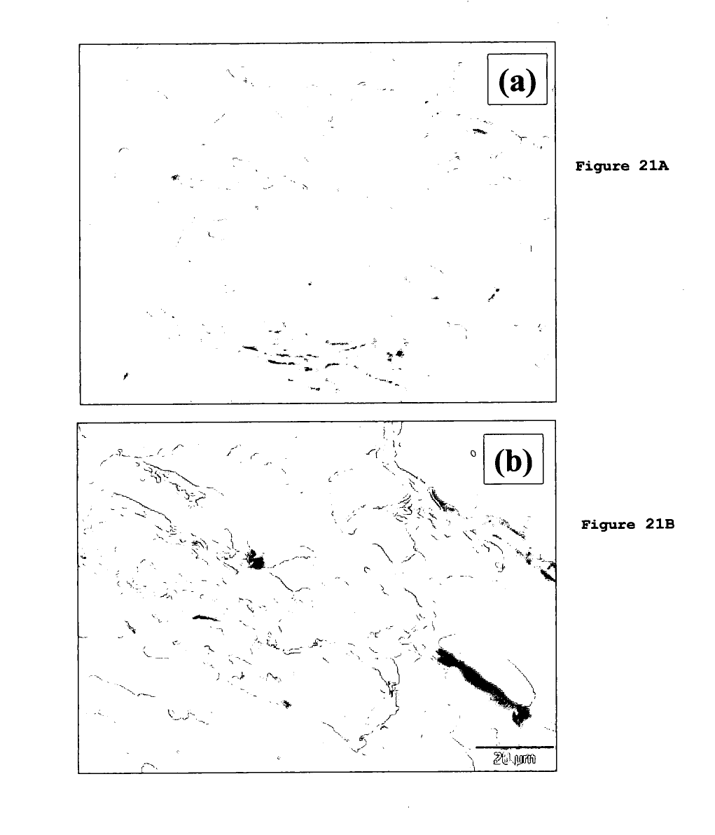

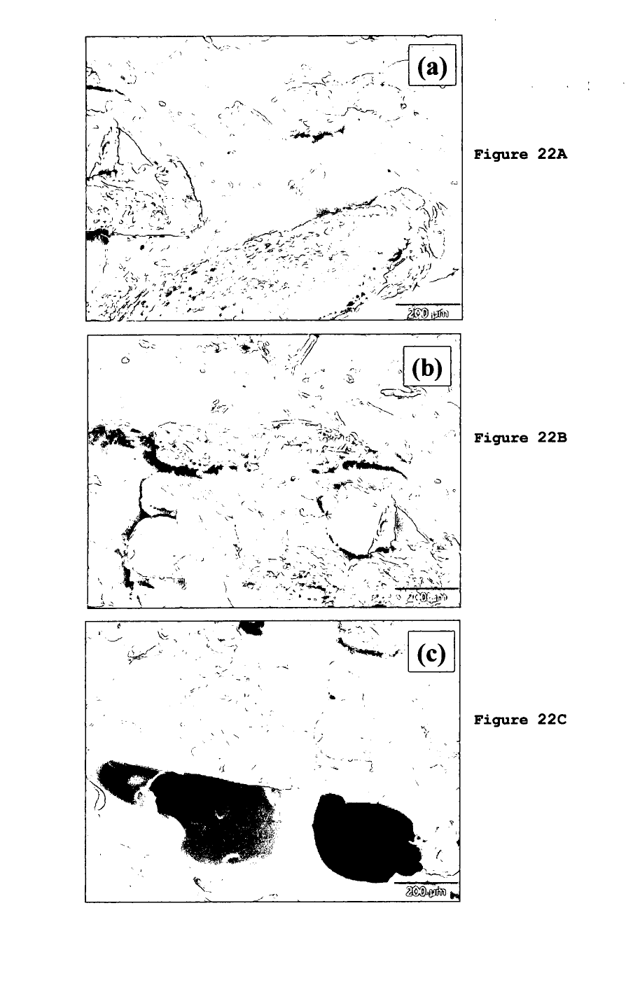

Morphology of the composites: SEM micrographs of the impact fracture surfaces of the composites are represented in FIGS. 20A and 20B, 21A and 21B, 22A to 22C and 23A and 23B. It is essential to observe the surface morphology, interfacial adhesion, and fracture dynamics of various composites for their better utility, because the efficiency of a fiber-reinforced composite depends on the fiber/matrix interface and the ability to transfer stress from the matrix to the fiber. SEM has been considered to be one of the powerful techniques to look at these aspects. In FIGS. 20A and 20B, the strong corncob-matrix bonding explains the good mechanical properties in composites reinforced with untreated corncobs. The fibers were covered with matrix, and the corncob pull out was less. No corncob bundles or large aggregates were observed. In FIGS. 21A and 21B, the surface had a consistent structure and very good dispersion of corncob is evident. The matrix-corncob interface was better defined with treated corncob. This result indicated why the storage modulus curves for composites of treated AFEX were higher than the composites of untreated corncobs. FIGS. 22A to 22C show the presence of corncob aggregation in the surface. Poor BCRL-matrix bonding of the liq. amo-treated corncob is shown in the micrograph. Large voids around the corncob surfaces are present.

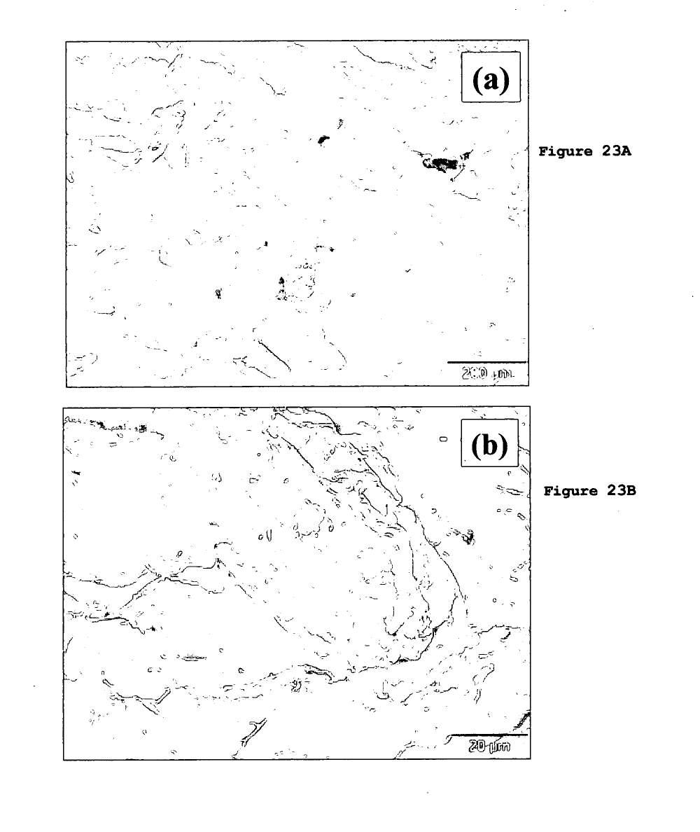

FIGS. 23A and 23B show silane (3-aminopropyl triethoxy silane) treated corncobs are well trapped by the PLA matrix. The corncob has been covered with a thin layer by the matrix linking the corncob surface to the matrix, and thus better stress transfer could be expected. The interfacial adhesiveness of the silane treated corncob reinforced composite is much better than that of the AFEX- or liq. amo.-treated corncob reinforced composite. The improvement of the interfacial adhesiveness by the surface treatment of corncobs should result in an improvement of the flexural properties. The treatment described in U.S. Pat. No. 7,094,451, which is incorporated herein by reference in its entirety and owned by a common assignee, can also be used.

### EXAMPLE 4

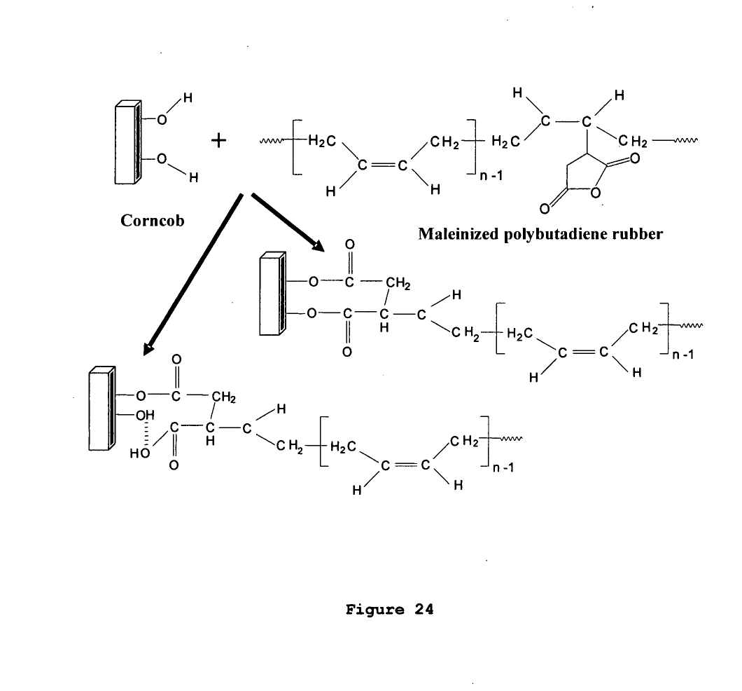

Processing of 10 maleinized polybutadiene rubber treated corncobs: To alleviate the poor compatibility problem between the natural fibers/fillers and hydrophobic polymers, various fiber/filler-polymer interface modifications have been proposed that results in improvement of performance of the resulting composite (Sreekala M S, Kumaran M G, Thomas S. The effect of hydrogen bonding on vapor diffusion in water-soluble polymers. J Appl Polym Sci 1997; 66: 821-291; Pochiraju K V, Tandon G P, Pagano N J. Analyses of single fiber push-out considering interfacial friction and adhesion, J Mechanics Phys Solids 2001; 49 (10): 2307). Chemical treatment to the fibers/fillers has often been carried out in order to overcome the problem of interfacial adhesion, in which significant change of mechanical properties of the fibers/fillers has been induced (Sreekala et al., supra). Generally, the fracture behavior of biocomposites modifies by fiber/filler coating that alters the mechanism of bond, stress states, and other thermo-mechanical properties at the fiber/filler-matrix interface region (Pochiraju et al., supra). Corncobs were treated with polybutadiene functionalized with maleic anhydride (Ricon 130MA13: from Sartomer Company, Inc. Exton, Pa.). This maleinized polybutadiene rubber was used as an impact modifier. The maleinized polybutadiene rubber was dissolved in Hexane by continuously stirring using a magnetic stir bar. The solution was sprayed to corncob and the mixture was stirred mechanically in a mixer for 15 min. The treated fibers were dried under the hood for 4 hours. The corncobs were then dried in a vacuum oven at 80° C. for 12 hours. They were then dried in an oven for 12 hours at 80° C. FIG. 24 shows a possible schematic diagram of the coating modification of the corncob surface (Sreekala et al., supra). Cellulose is the essential component of all plant-fibers. The elementary unit of a cellulose macromolecule is anhydro-d-glucose, which contains three hydroxyls (—OH). These hydroxyls form hydrogen bonds inside the macromolecule itself (intramolecular) and between other cellulose macromolecules (intra-molecular) as well as with hydroxyl groups from the air. X-ray photon spectroscopy (XPS) survey scan was taken for rubber-treated corncob granules and Table 7 shows the elemental composition of the corncobs. In the case of the rubber treatment, the oxygen, nitrogen, and carbon concentrations on the corncob surface decreased and the presence of silicon on the surface was appeared due to the composition of the maleinized polybutadiene rubber coating of the corncob surface.

TABLE 7
Elemental composition of rubber-treated corncob
granules (from X-ray photon spectroscopy).

| | C | O | N | Si |
|---|---|---|---|---|
| | 1s | 1s | 1s | 2p |
| Samples | [0.314] | [0.733] | [0.499] | [0.368] |
| Untreated | 76.08 | 21.98 | 1.95 | — |
| corncobs | | | | |
| Rubber treated | 85.36 | 12.29 | 1.46 | 0.90 |
| corncobs | | | | |

### EXAMPLE 5

Organosolv treated for increasing solubility of lignin in corn cob granules (CCG): This pretreatment involves using different combinations of ethanol and sulfuric acid and has been reviewed recently (Arato C, Pye E K, Gjennestad, G (2005) The lignol approach to bio-refining of woody biomass to produce ethanol and chemicals, Appl. Biochem. Biotechnol. 121-124: 871-882). A modified organosolvent treatment was used, where CCG was mixed with ethanol and water (80:20) at pH 1-14 in 1:2 (w/v) ratios and heated up to 100° C. in a closed stainless steel high pressure reactor for 30 minutes. Then the vent was explosively released and the resultant biomass was dried over night in a hood.

Gaseous Ozone treated CCG: Ozonization of wood and other lignocelluloses has been studied many times with regard to complete structure breakup (i.e., pulping) (Neely W C (1984) Factors affecting the pretreatment of biomass with gaseous ozone, Biotechnol. Bioeng. 26: 59-75). A similar approach was used to treat the CCG to improve its properties. The CCG was exposed to ozone/oxygen gas stream saturated with water in a rotating horizontal cylinder. During the process CCG was tumbled while being exposed to an ozone flow for a period of 30 minutes.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

### REFERENCES CITED

1. G. 0. Benson and R. B. Pearce, in “Corn: Chemistry and Technology”, S. A. Watson and P. E. Ramsted, Eds., AACC, St. Paul, MN, 1987, pp. 1-28.
2. USDA, “Agricultural Statistics 1993”, U.S. Government Printing Office, Washington, DC, 1993.
3. Mohanty, A. K.; Misra, M; Drzal, L.T. J Polym Environ 2002, 10, 19.
4. Gassan, J.; Bledzki, A. K. Prog Polym Sci 1999, 24(2), 221.
5. Mohanty, A. K.; Misra, M.; Hinrichsen, G. Macromol Mater Eng 2000, 276/277, 1.
6. Balatinecz, J. J.; Woodhams, R. T., J. Forestry 1993, 91 (11), 22.
7. Chtourou, A., Riedl, B., Ait-Kadi, A., 1992. J. Reinf. Plast. Comp. 11, 372-394.
8. Mwaikambo, L. Y., Ansell, M. P., 2002. J. Appl. Polym. Sci. 84, 2222-2234.
9. Jayaraman, K., 2003. Compos. Sci. Technol. 63, 367-374.
10. Gassan, J., Bledzki, A. K., Composites Part A.28A, 993-1000.
11. Woodhams, R. T., Thomas, G., Rodgers, D. K., 1984. Polym. Eng. Sci. 24, 1166-1171.
12 Rouison, D., Couturier, M., Sain, M., 2004. SAE Paper No. 2004-01-0728.
13. Raj, R. G., Kokta, B. V., Nizio, J. D., 1992. J. Appl. Polym. Sci. 45, 91-101.
14. Matuana, L. M., Park, C. B., Balatinecz, J. J., 1998. Polym. Eng. Sci. 38 (11), 1862-1872.
15. Joshi, S. V.; Drzal L. T.; Mohanty, A. K.; Arora, S. Compos. Part A: Appl. Sci. Manu. 2004, 35, 371-376.
16. Mohanty, A. K.; Wibowo, A.; Misra, M.; Drzal, L. T. Compos. Part A: Appl. Sci. Manu. 2004, 35, 363-370.
17. Finegan, I. C.; Gibson, R. F.; Compos. Strs. 1999, 44, 89-98.
18. Hatakeyama, H. S.; Hirose, K.; Nakamura, H.; Tatsuko, K. Cellulosics: Chemical, Biochemical and Material Aspects. Kennedy, J. F.; Phillips, G. O.; Williams, P. A. Ed.; Ellis Horwood: Chichester, p. 525, 1993.
19. Pukanszky, B. Polypropylene: structure, blends and composites. Karger-Kocsis, J. Ed.; Chapman and Hall: London, p. 1-70, 1995.
20. Qiu, W.; Mai, K.; Zeng, H. Effect of silane-grafted polypropylene on the mechanical properties and crystallization behavior of talc/polypropylene composites, J. Appl. Polym. Sci. 2000, 77, 2974-2977.
21. Velasco. J. I.; de Saja J. A.; Martinez, A. B. Crystallization Behavior of Polypropylene Filled with Surface-Modified Talc. J. Appl. Polym. Sci. 1996, 61, 125-132.
22. Vink, E. T. H.; Ra bago, K. R.; Glassner, D. A.; Gruber, P. R. Polym Degradation and Stability 2003, 80(3), 403.
23. O'Brien, M.; Gray, J. Federal Trade Commission Announces New Fiber Generic: Cargill Dow's Natureworks™ fibers Receive First Designation of the Century. Internet. March 2002.
24. Verespej, M. Winning Technologies: Polylactic Polymers. Industry Week, Dec. 11, 2000.
25. Huda, M. S.; Mohanty, A. K.; Misra, M; Drzal, L. T.; Schut, E. J Mater Sci 2005, 40, 4221.
26. Oksman, K.; Skrifvars, M; Selin, J. F. Compos Sci Tech 2003, 63, 1317.
27. Plackett , D.; J Polym Environ 2004, 12, 131
28. Kasuga, T.; Ota,Y.; Nogami, M.; Abe, Y. Biomaterials 2001, 22, 19.
29. Matuana, L. M., Park, C. B., Balatinecz, J. J., 1997. J. Polym. Eng. Sci. 37 (7), 1137-1147.
30. Glassner, D., Hettenhaus, J., and Schechinger, T.: Corn stover potential: recasting the corn sweetener industry, p. 74-82. In Janick, J. (ed.), Perspectives on new crops and new uses. ASHS Press, Alexandria, Va. (1999).
31. P. J. Herrera-Franco, A. Valadez-Gonzalez, Composites: Part A 35 (2004) 339.
32. Dale, B. E., Biotechnology Progress 15 (1999) 775.
33. Dale, B. E., Moreira, M. J., 1983. Biotechnology and Bioengineering Symp. 12, p. 13.
34. Lewin, M., and Roldan, L. G., J. Polym. Sci. Part C 36, 213-229 (1971).
35. Pandy, S. N., and Navir, P. A., Textile Res. J. 45, 648-651 (1975).
36. Hyn M., Steiner W. Klinger R, Steinmuller H, Sineer M, Esterbauer H. Basic research and pilot studies on the enzymatic conversion of lignocellulosic. In: Saddler J. N. (Ed.). Bioconversion of forest and agricultural plant residues. 1993 CAB International, Wallingfored, UK. P. 33-72.
37. Shibata, M., K. Ozawa, N. Teramoto, R. Yosmiya, and H. Takeishi. Macromol. Mater. Eng., 288 (2003) 35.
38. Agrawal, R., N. S. Saxena, K. B. Sharma, S. Thomas, and M. S. Sreekala, Materials Science and Engineering A277 (2000) 77.
39. Rana, A. K., B. C. Mitra, and A. N. Banerjee. J Appl Polym Sci., 71 (1999) 531.
40. Charto, R. P. “Thermal characterization of polymeric materials,” in Thermoplastic polymers, E. A. Turi, editor. Vol. 1, 2nd ed. Academic Press, 1997. chapter 3.
41. Reed, P. E. and L. Beva. Polym Comp.,14 (1993) 286.
42. Sela, N. and O. Ishai. Composites, 20(5) (1989) 423.

We claim:

1. A composite composition which comprises:
(a) a synthetic polymer; and
(b) corncob granules which have been modified so as to be compatible with the polymer to form the composition.

2. The composite of claim 1 wherein the corncob granules surface and cell wall ultra-structural properties have been modified with a chemical.

3. The composite of claim 1 wherein the corncob granules have been modified by UV-ozone or plasma treatment of the corncob granules.

4. The composite of claim 1 wherein the corncob granules have been modified by mechanical modification with high-frequency ultrasound.

5. The composite of claim 1 wherein the polymer is biodegradable.

6. The composite of claim 1 wherein the polymer is polylactic acid (PLA).

7. The composite of claim 2 wherein the chemical is a silane, maleic anhydride grafted polylactic acid (PLA), maleic anhydride grafted polyhydroxyalkanoate (PHA), maleic anhydride grafted polyolefin, maleic anhydride grafted rubber, unsaturated polyester, epoxy or isocyanate.

8. The composition of claim 7 wherein the polyolefin is polypropylene (PP), polyethylene (PE) or copolymers thereof.

9. The composite of any one of claims 1, 2, 3 or 4 which has been extruded.

10. The composite of any one of claims 1, 2, 3 or 4 which has been extruded, pelletized and then injection molded.

11. The composite of claim 2 wherein the corncob granules have been expanded in an AFEX ammonia process, wherein the ammonia reacts with the granules.

12. The composite of any one of claims 1, 2, 3 or 4 wherein the granules are up to about 80% by weight of the composition.

13. The composite of claim 2 wherein the corn cob granules have been modified with gaseous ozone.

14. The composite of claim 2 wherein the corn cob granules have been modified with organosolvent.

15. The composite of claim 2 wherein the corn cob granules have been modified by reaction with an alkali metal hydroxide.

16. The composite of claim 3 wherein the corn cob granules have been modified by UV-ozone or plasma treatment in the presence of an aqueous silane.

17. A process for the preparation of a composite composition comprising: a synthetic polymer and corncob granules which have been modified to be compatible with the polymer, which comprises: blending at elevated temperatures, the polymer so as to be thermoplastic and the corncob granules to form the composite composition.

18. The process of claim 17 wherein the blending is by extrusion.

19. The process of claims 17 or 18 wherein the corncob granules have been modified with a chemical which reacted with the hydroxyl groups on the granules.

20. The process of claims 17 or 18 wherein the corncob granules have been modified by UV-ozone or plasma treatment of the corncob granules.

21. The process of claims 17 or 18 wherein the corncob granules have been modified by mechanical modification with high-frequency ultrasound.

22. The process of claims 17 or 18 wherein the polymer is biodegradable.

23. The process of claims 17 or 18 wherein the polymer is polylactic acid (PLA).

24. The process of claim 19 wherein the chemical is a silane, maleic anhydride grafted polylactic acid (PLA), maleic anhydride grafted polyhydroxyalkanoate (PHA), maleic anhydride grafted polyolefin, maleic anhydride grafted rubber, unsaturated polyester, epoxy or isocyanate.

25. The process of claim 24 wherein the polyolefin is polypropylene (PP), polyethylene (PE) or copolymers thereof.

26. The process of claim 18 which has been extruded, pelletized and then injection molded.

27. The process of claim 17 wherein the corncob granules have been expanded in an AFEX ammonia process, wherein the ammonia reacts with the granules.

28. The process of claims 17 or 18 wherein the granules are up to about 80% by weight of the composition.

29. The process of claims 17 or 18 wherein the corn cob granules have been modified with gaseous ozone.

30. The process of claims 17 or 18 wherein the corn cob granules have been modified with organosolvent.

31. The process of claims 17 or 18 wherein the corn cob granules have been modified by reaction with an alkali metal hydroxide.

32. The process of claims 17 or 18 wherein the corn cob granules have been modified by UV-ozone or plasma treatment in the presence of an aqueous silane.
